(19) United States
(12) Patent Application Publication
(10) Pub. No.: US 2005/0060303 A1
(43) Pub. Date: Mar. 17, 2005

(54) Patent family analysis system and method

(76) Inventors: Qing-Ming Wu, Shenzhen (CN); Chien-Fa Yeh, Tu-Chen (TW); Chung-I Lee, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/940,244

(22) Filed: Sep. 13, 2004

(30) Foreign Application Priority Data
Sep. 12, 2003 (TW) 92125265

(51) Int. Cl. G06F 17/30

(52) U.S. Cl. 707/3

(57) ABSTRACT

A patent family analysis system includes a number of client computers (10), an application server (12), and a database server (14). The application server includes a patent family searching device (120), a patent family analysis device (121), and a controlling device (122). Any of the client computers may receive information of a patent whose patent family needs to be analyzed. The database server searches for corresponding patent family data according to the patent information. The analysis device then analyzes the patent family data according to a selected analysis type for the patent family, and generates patent family analysis results. The patent family analysis results are displayed through the client computer. A related patent family analysis method is also provided.

### BACKGROUND OF THE INVENTION

1. Field of the Invention

The present invention relates to systems and methods for managing patent data, and particularly to a system and method for analyzing groups of related patents known as a patent family.

2. Background of the Invention

A patent family is defined as a group of patent filings in various countries/institutions that claim the priority of a single filing in one of those countries/institutions. That is, a patent family includes the original priority filing itself, and all subsequent related filings made in other countries/institutions throughout the world. Patent family analysis plays an important role in comprehending competitors' product strategies and product development in a particular technological field. For instance, patent family analysis of a particular company can help to analyze strategies of patent distribution and product development of the company. In addition, patent family analysis of a particular technological field can help to understand a state of development of the technology in various countries and regions.

U.S. Pat. No. 6,339,767 issued on Jan. 12, 2002 and entitled Using Hyperbolic Tree to Visualize Data Generated by Patent-Centric and Group-Oriented Data Processing discloses a system and method for processing patent data. The system maintains first databases of patents, and second databases of non-patent information of interest to a corporate entity. The system also maintains one or more groups. Each of the groups comprises any number of the patents from the first databases. The system, upon receiving appropriate operator commands, automatically processes the patents in one of the groups in conjunction with non-patent information from the second databases. Accordingly, the system performs patent-centric and group-oriented processing of data. A group can also include any number of non-patent documents. The groups may be product based, person based, corporate entity based, or user-defined. Other types of groups are also covered, such as temporary groups. The processing automatically performed by the system mainly relates to patent mapping, document mapping, patent citation (both forward and backward), patent aging, patent bracketing clustering (both forward and backward), inventor patent counts, inventor employment information and patent claim tree analysis. However, the system described above does not deal with how to analyze patent families.

Present-day patent family databases, such as the LexisNexis Corporation database, enable users to search patent family data by patent number or by company name at the providing companies' websites. However, it is not convenient for general users to read the search results, because patent family data downloaded from the databases need to be further arranged in order to be useful. In addition, when a user selects patent numbers as one of the search conditions, it is laborious and time-consuming to input patent numbers one by one. Furthermore, when the scope of patents to be analyzed is very wide, a user needs to repeat the procedure of inputting patent numbers and analysis conditions several times. This is because the length of key words for searching is limited. Therefore, a system and method for analyzing patent families which overcomes the above-mentioned problems is desired.

### SUMMARY OF THE INVENTION

A main objective of the present invention is to provide a patent family analysis system and method which can analyze patent families conveniently according to selected patent family analysis types.

To accomplish the above objective, a patent family analysis system in accordance with a preferred embodiment of the present invention comprises a plurality of client computers, an application server, a database and a database server. Each client computer includes an interactive user interface and an output device. Through the interactive user interface, a user can select a patent whose patent family needs to be analyzed, and a patent family analysis type. The interactive user interface is also used to display patent family analysis results. The output device is for outputting and exporting the patent family analysis results in an appropriate form. The form can be image figures or Microsoft Excel sheets. The application server comprises a patent family searching device, a patent family analysis device and a controlling device. The patent family searching device is provided for automatically searching for patent family data according to patent information of the selected patent. The patent information is stored in the database. The patent family analysis device is provided for automatically analyzing the patent family data to generate patent family analysis results according to a selected patent family analysis type. The controlling device is provided for controlling operations of the patent family analysis device, and interactions between the patent family analysis device and the client computers. The controlling device can also receive the selected patent family analysis type, and transmit the selected patent family analysis type to the patent family analysis device. The controlling device further receives the patent family analysis results, and transmits the patent family analysis results to the output device.

Further, the present invention provides a patent family analysis method. The method comprises the steps of: (a) providing a plurality of client computers, each of the client computers comprising a user interface for enabling a user to select a patent whose patent family needs to be analyzed; (b) providing a patent family searching device for receiving information of the selected patent, and generating a patent family searching sentence according to the information; (c) providing a database server for receiving the patent family searching sentence, and searching for patent family data on the selected patent using the patent family searching sentence; (d) selecting a patent family analysis type for analyzing the patent family through the user interface; (e) providing a patent family analysis device for analyzing the patent family data according to the patent family analysis type, and generating patent family analysis results; and (f) displaying the patent family analysis results through the user interface.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware configuration of a patent family analysis system in accordance with the preferred embodiment of the present invention;

FIG. 2 is a schematic diagram of main function devices of the patent family analysis system of FIG. 1;

FIG. 3 is a schematic diagram of data flow of the patent family analysis system; and

FIG. 4 is a flowchart of a preferred method for analyzing patent family data by implementing the patent family analysis system according to the present invention.

### DETAILED DESCRIPTION OF THE PREFERRED EMBODIMENT

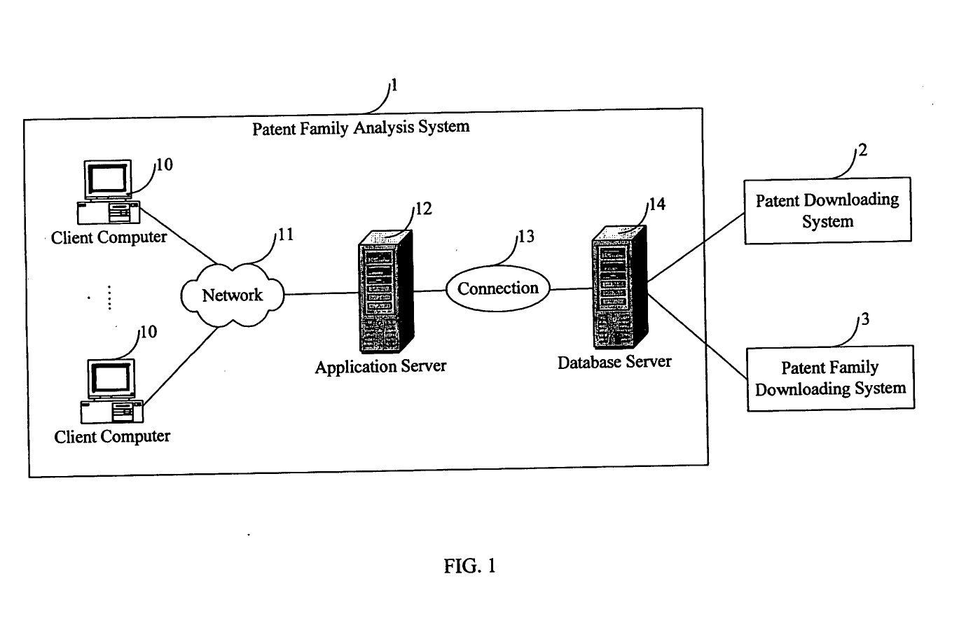

FIG. 1 is a schematic diagram of hardware configuration of a patent family analysis system 1 in accordance with the preferred embodiment of the present invention. The patent family analysis system 1 includes a plurality of client computers 10, an application server 12, and a database server 14. The client computers 10 are connected to the application server 12 through a network 11. The network 11 may be an intranet, the Internet, or any other suitable type of communication network. The application server 12 is connected to the database server 14 through a connection 13. The connection 13 is a database connectivity such as an ODBC (Open Database Connectivity) or a JDBC (Java Database Connectivity). The database 140 is provided for storing patent data and patent family data. The patent data are downloaded from a patent downloading system 2. The patent family data are downloaded from a patent family downloading system 3. The application server 12 analyzes patent family data for various patents, and transmits patent family analysis results to the client computers 10.

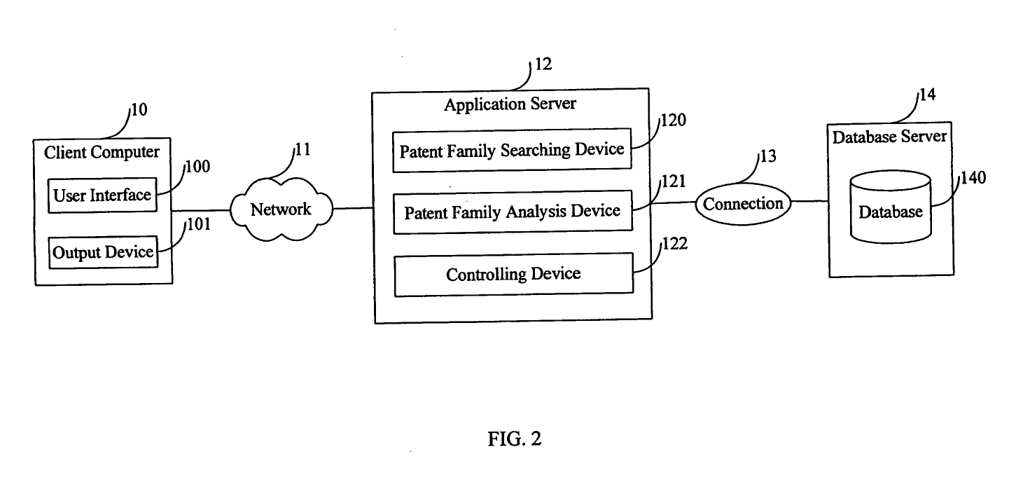

FIG. 2 is a schematic diagram of main function devices of the patent family analysis system 1, showing only one of the client computers 10. The client computer 10 comprises a user interface 100 and an output device 101. The user interface 100 is an interactive interface for users of the patent family analysis system 1 to implement corresponding operations, and for displaying patent family analysis results. Said operations comprise: selecting a patent whose patent family needs to be analyzed, selecting a patent family analysis type, and determining whether patent family analysis results need to be exported. The patent family analysis type can be an assignee analysis, a patent family distribution analysis, or a patent classification analysis. A patent classification is defined by a user according to technical characteristics of patents. The assignee analysis calculates a total number of patents that belong to each assignee, a number of patents that are applied for or issued during a selected period, and a number of patents that belong to a same patent classification. The patent family distribution analysis calculates numbers of patents distributed in different areas of technology, numbers of patents distributed in different areas of technology during various periods, and numbers of patents distributed in different areas of technology and their different patent classifications. The patent classification analysis calculates numbers of patents that belong to various patent classifications, and numbers of patents that belong to various patent classifications during various periods. The output device 101 receives and exports the patent family analysis results in an appropriate form. Typical export forms comprise image figures and Microsoft Excel sheets.

The database server 14 comprises a database 140. The database 140 stores patent data downloaded from the patent downloading system 2 and patent family data downloaded from the patent family downloading system 3.

The application server 12 comprises a patent family searching device 120, a patent family analysis device 121, and a controlling device 122. The patent family searching device 120 receives a selected patent whose patent family needs to be analyzed, and generates a patent family searching sentence according to information of the selected patent. The patent family searching sentence is transmitted to the database server 14 by the controlling device 122. The database server 14 searches for corresponding patent family data in the database 140 according to the patent family searching sentence, and transmits the patent family data to the patent family analysis device 121.

The patent family analysis device 121 receives the patent family data and a patent family analysis type. The patent family analysis device 121 analyzes the patent family data according to the patent family analysis type, and generates patent family analysis results. Then the patent family analysis device 121 transmits the patent family analysis results to the controlling device 122.

The controlling device 122 controls operations of the patent family analysis device 121, and interactions between the patent family analysis device 121 and the client computers 10. The controlling device 122 can also receive the selected patent family analysis type, and transmits the selected patent family analysis type to the patent family analysis device 121. The controlling device 122 further receives the patent family analysis results, and transmits the patent family analysis results to the output device 101. The output device 101 outputs and exports the patent family analysis results through the user interface 100.

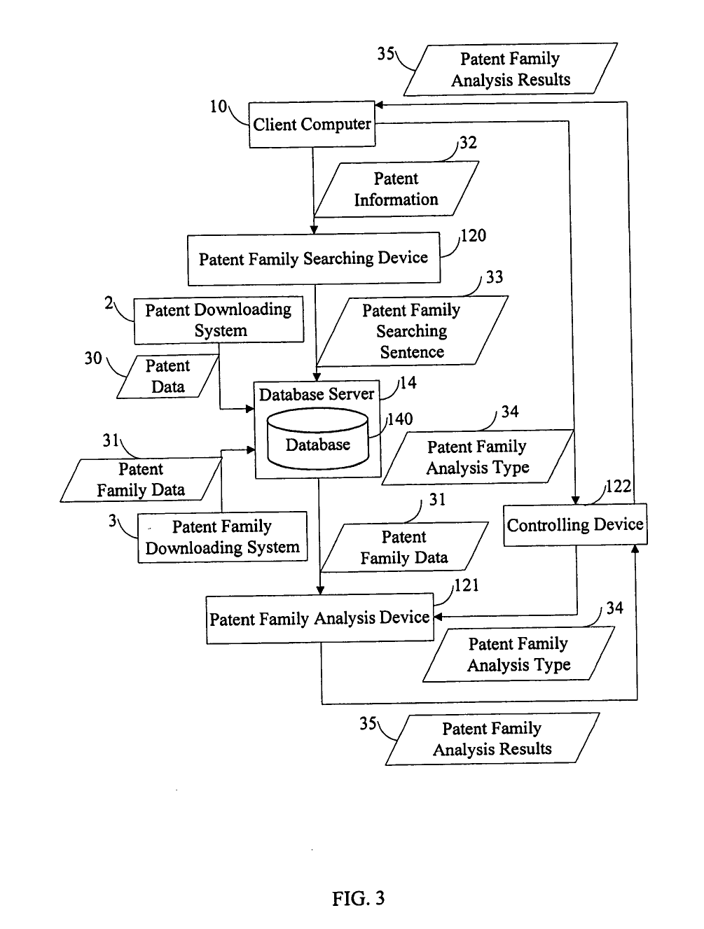

FIG. 3 is a schematic diagram of data flow of the patent family analysis system 1. The database server 14 receives patent data 30 downloaded from the patent downloading system 2 and patent family data 31 downloaded from the patent family downloading system 3, and stores the patent data 30 and the patent family data 31 in the database 140. The client computer 10 receives patent information 32 of a selected patent, and transmits the patent information 32 to the patent family searching device 120. The patent family searching device 120 generates a patent family searching sentence 33 according to the patent information 32. Then the database server 14 searches for corresponding patent family data 31 from the database 140 according to the patent family searching sentence 33. Then the patent family searching device 120 transmits the patent family data 31 to the patent family analysis device 121. The client computer 10 receives a patent family analysis type 34 selected by a user, and transmits the patent family analysis type 34 to the controlling device 122. The controlling device 122 transmits the patent family analysis type 34 to the patent family analysis device 121. The patent family analysis device 121 obtains the patent family data 31 from the database 140, analyzes the patent family data 31 according to the patent family analysis type 34, and generates patent family analysis results 35. The controlling device 122 transmits the patent family analysis results 35 to the client computer 10.

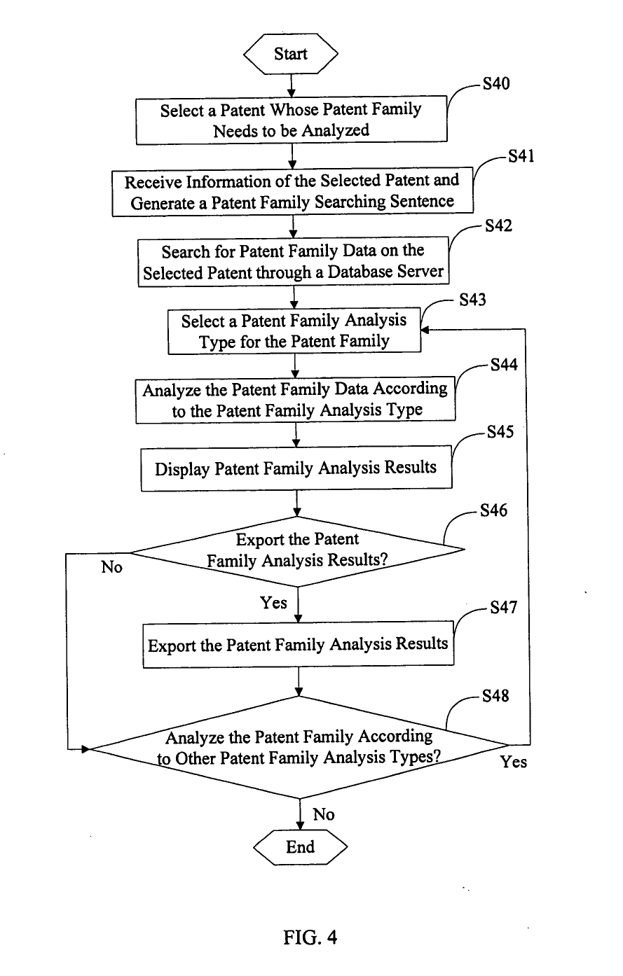

FIG. 4 is a flowchart of a preferred method for analyzing patent family data by implementing the patent family analysis system 1 according to the present invention. In step S40, a user selects a patent whose patent family needs to be analyzed through the user interface 100. In step S41, the patent family searching device 120 receives information of the selected patent from the database 140, and generates a patent family searching sentence. In step S42, the database server 14 searches for corresponding patent family data from the database 140 according to the patent family searching sentence. The controlling device 122 transmits the patent family data to the patent family analysis device 121. In step S43, the user selects a patent family analysis type for the patent family. The controlling device 122 transmits the patent family analysis type to the patent family analysis device 121. In step S44, the patent family analysis device 121 analyzes the patent family data according to the patent family analysis type, and generates patent family analysis results. In step S45, the controlling device 122 transmits the patent family analysis results to the output device 101. The output device 101 outputs the patent family analysis results through the user interface 100 in an appropriate form. In the step S46, the user determines whether there is a need to export the patent family analysis results. If there is no need to export the patent family analysis results, the procedure goes directly to step S48 described below. If there is a need to export the patent family analysis results, in step S47, the output device 101 exports the patent family analysis results in an appropriate form, whereupon the procedure goes to step S48. In step S48, the user determines whether there is a need to further analyze the patent family according to other analysis types. If there is no need to further analyze the patent family, the procedure is ended; otherwise, the procedure returns to step S43 described above.

In general, the patent family analysis system and method of the present invention may take forms other than what is described above. While preferred embodiments for carrying out the present invention have been described in detail, those familiar with the art to which the invention relates will recognize various alternative designs and embodiments for practicing the present invention. These alternative designs and embodiments are within the scope of the present invention, which is defined by the claims appended hereto and allowable equivalents thereof.

1. A patent family analysis system comprising:
a database server provided for accessing patent data and patent family data;
a plurality of client computers, each of the client computers including a user interface for enabling a user to select a patent whose patent family needs to be analyzed and a patent family analysis type; and
an application server connecting to the database server and the client computers, the application server comprising:
a patent family searching device provided for automatically generating a patent family searching sentence according to information of a selected patent, the patent family searching sentence being used by the database server to search patent family data of the selected patent;
a patent family analysis device provided for automatically analyzing the patent family data according to the selected patent family analysis type, and generating patent family analysis results; and
a controlling device provided for controlling operations of the patent family analysis device and interactions between the patent family analysis device and the client computers.

2. The system as claimed in claim 1, wherein the database server comprises a database for storing the patent data and the patent family data.

3. The system as claimed in claim 1, wherein each of the client computers further comprises an output device for outputting and exporting the patent family analysis results in an appropriate form.

4. A computer-based patent family analysis method, the method comprising the steps of:
(a) providing a client computer for a user to select a patent whose patent family needs to be analyzed;
(b) providing a patent family searching device for receiving information of the selected patent and generating a patent family searching sentence according to the received patent information;
(c) providing a database server for receiving the patent family searching sentence, and searching for patent family data of the selected patent using the patent family searching sentence;
(d) selecting a patent family analysis type for analyzing the patent family;
(e) providing a patent family analysis device for analyzing the patent family data according to the selected patent family analysis type, and generating patent family analysis results; and
(f) displaying the patent family analysis results.

5. The method as claimed in claim 4, further comprising the steps of providing a controlling device and using the controlling device to control operations of the patent family analysis device and interactions of the patent family analysis device with the client computer.

6. The method as claimed in claim 4, further comprising the steps of providing a database, and storing patent data and patent family data in the database.

7. The method as claimed in claim 4, further comprising the steps of providing an output device in the client computer, and outputting and/or exporting the patent family analysis results in an appropriate form.

8. The method as claimed in claim 4, wherein the patent family analysis type comprises any one or more of an assignee analysis, an area of technology distribution analysis, and a user-defined classification analysis.

9. A computer-based patent family analysis method, the method comprising the steps of:
(a) providing a patent family searching device for receiving information of a selected patent and generating a patent family searching criteria according to the received patent information;
(b) providing a database server for receiving the patent family searching criteria, and searching for patent family data of the selected patent using the patent family searching criteria;
(c) selecting a patent family analysis type for analyzing the patent family;
(d) providing a patent family analysis module for analyzing the patent family data according to the selected patent family analysis type, and generating patent family analysis results; and
(e) displaying the patent family analysis results.
